(19) United States
(12) Patent Application Publication
(10) Pub. No.: US 2014/0201505 A1
(43) Pub. Date: Jul. 17, 2014

(54) PREDICTION-BASED THREAD SELECTION IN A MULTITHREADING PROCESSOR

(71) Applicants: Matthew C. Merten, Hillsboro, OR (US); Tong Li, Portland, OR (US); Vijaykumar B. Kadgi, Portland, OR (US); Srikanth T. Srinivasan, Portland, OR (US); Christine E. Wang, Portland, OR (US)

(72) Inventors: Matthew C. Merten, Hillsboro, OR (US); Tong Li, Portland, OR (US); Vijaykumar B. Kadgi, Portland, OR (US); Srikanth T. Srinivasan, Portland, OR (US); Christine E. Wang, Portland, OR (US)

(21) Appl. No.: 13/997,837

(22) PCT Filed: Mar. 30, 2012
(86) PCT No.: PCT/US2012/031634

§ 371 Date: Jun. 25, 2013

(51) Int. Cl. G06F 9/30

(52) U.S. Cl. CPC G06F 9/30145
USPC 712/226

(57) ABSTRACT

A processor includes one or more execution units to execute instructions of a plurality of threads and thread control logic coupled to the execution units to predict whether a first of the plurality of threads is ready for selection in a current cycle based on readiness of instructions of the first thread in one or more previous cycles, to predict whether a second of the plurality of threads is ready for selection in the current cycle based on readiness of instructions of the second thread in the one or more previous cycles, and to select one of the first and second threads in the current cycle based on the predictions.

### TECHNICAL FIELD

Embodiments of the present invention relate generally to multithreading processors. More particularly, embodiments of the invention relate to thread selection based on prediction in a multithreading processor.

### BACKGROUND ART

Many modern computer systems are able to execute more than one distinct software program, or “thread”, without having to explicitly save the state for one thread and restore the state for another thread. For this reason they are referred to as “multi-threaded” computer systems. In one older approach, called sequential multi-threaded operation, the operating system or other control mechanism permits the several threads to share resources by permitting each thread that is a candidate for execution to operate in sequence on the processor. Changing between threads may be referred to as thread switching. In some of these older approaches, threads are switched when the currently executing thread executes for a certain period or reaches a point when it cannot proceed, such as waiting for a memory access or an input/output (I/O) transfer to finish, or simply to ensure fairness amongst the tasks. The selection of the next thread to be switched in (permitted use of execution resources) may be made on the basis of strict priority. In other approaches, a round-robin approach may be used in thread switching. Several modern microprocessors support what is known as simultaneous (or concurrent) multi-threaded operation. In these processors, several threads may execute simultaneously sharing resources in parallel rather than in sequence.

A multithreading processor such as a simultaneous-multithreading (SMT) processor often requires some control algorithm to select which thread to retire when multiple threads are ready to retire at the same time. A conventional approach is to round-robin among the ready threads. For example, for a two-thread SMT processor, the two threads essentially PING-pong between each other. This approach, however, can consume a lot of power due to frequent thread switching.

### BRIEF DESCRIPTION OF THE DRAWINGS

Embodiments of the invention are illustrated by way of example and not limitation in the figures of the accompanying drawings in which like references indicate similar elements.

FIGS. 1A and 1B are block diagrams illustrating an example of a processor according certain embodiments of the invention.

FIG. 2 is a block diagram illustrating a thread selection scheme according to one embodiment of the invention.

FIG. 3 is a block diagram illustrating an example of a thread selection according to another embodiment of the invention.

FIG. 4 is a flow diagram illustrating a method for thread selection according to one embodiment of the invention.

FIG. 5 is a flow diagram illustrating a method for thread selection according to another embodiment of the invention.

FIG. 6 is a flow diagram illustrating a method for thread selection according to another embodiment of the invention.

FIG. 7 is a block diagram illustrating an example of a data processing system according to one embodiment.

FIG. 8 is a block diagram illustrating an example of a data processing system according to one embodiment.

### DESCRIPTION OF THE EMBODIMENTS

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to some embodiments, an optimized thread selection scheme is utilized to select a thread that leads to fewer thread switching and still provides high performance. In one embodiment, in deciding which of a first thread and a second thread should be selected, for example, for retirement, a thread selection logic of a processor is to predict whether the first thread and the second thread are ready for selection based on readiness of one or more instructions (or micro-operations (μOps)) of the first and second threads in a previous cycle. According to one embodiment, if there is at least one instruction or μOp that was not ready for selection in the previous cycle (e.g., the last cycle immediately preceding to the current cycle), the corresponding thread is considered not ready for the current cycle. One of the first and second threads that is considered ready is then selected based on the predictions of the first and second threads. The readiness of the instructions or μOps is determined based on whether the instructions or μOps have been executed by the execution units and ready for retirement by a retirement unit of a processor.

If both the first and second threads are considered to be ready for selection, for example, for retirement, according to one embodiment, a contention resolution algorithm is applied to decide which of the first and second threads should be selected in the current cycle. In one embodiment, if one of the thread (e.g., first thread) was selected in the last cycle but a number of consecutive previous selections of the same thread has not exceeded a predetermined number cycles, the same thread (e.g., first thread) is selected again in the current cycle. Otherwise, if the number of consecutive previous selections of a thread (e.g., first thread) that was selected in the last cycle has reached the predetermined threshold, another thread (e.g., second thread) is selected for the current cycle. As a result, a thread would not be switched out even if it was selected in the last cycle, unless it has been selected for a predetermined number of consecutive cycles. The predetermined threshold may be configured or programmed dependent upon a specific configuration to reduce amount of thread switching while maintaining performance of the processor. The thread control logic is to maintain such thread selection heuristics for certain amount of thread selections of previous cycles to be utilized for prediction and selection of a thread in the current cycle. Throughout this application, for the purpose of illustration, thread selection techniques are described in view of thread retirement purposes; however, the thread selection techniques can also be utilized for other purposes, such as instruction fetching or execution, etc.

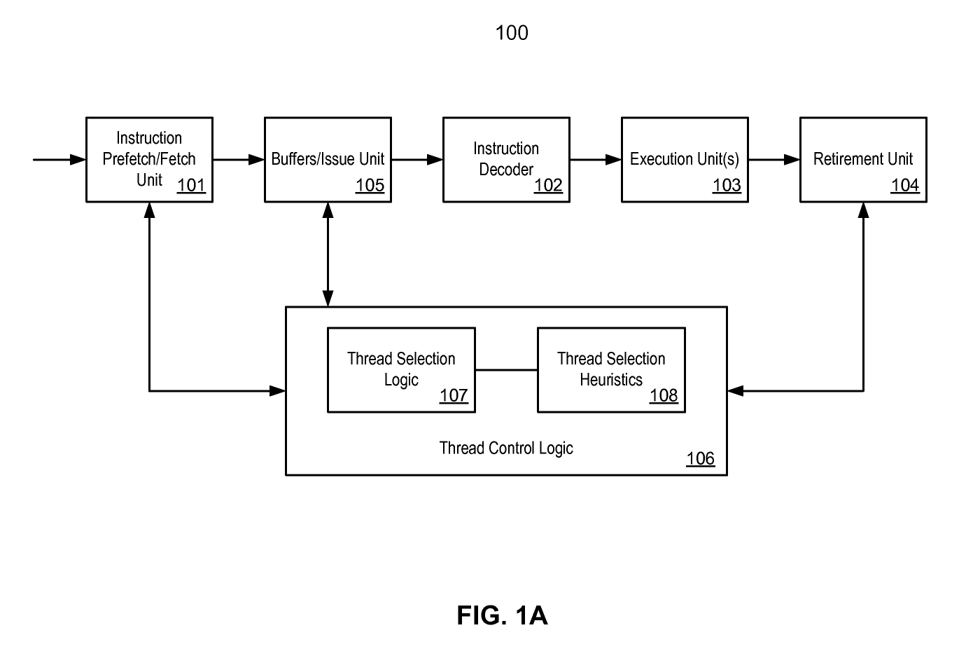

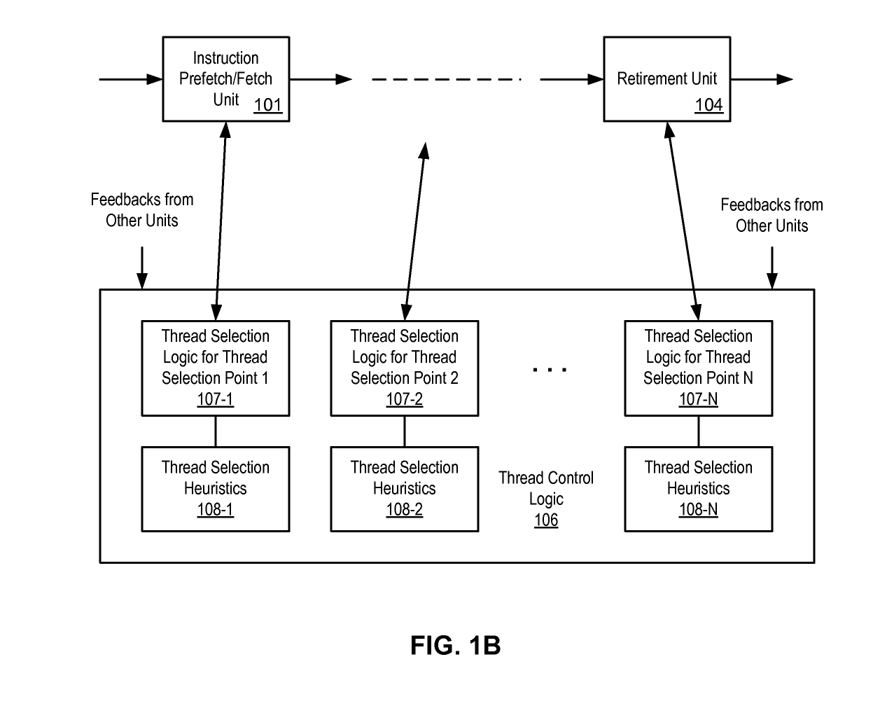

FIG. 1A is a block diagram illustrating an example of a processor according one embodiment of the invention. Processor 100 may be an SMT capable processor available from Intel Corporation of Santa Clara, Calif. For example, processor 100 may be a general-purpose processor. Processor 100 may be any of various complex instruction set computing (CISC) processors, various reduced instruction set computing (RISC) processors, various very long instruction word (VLIW) processors, various hybrids thereof, or other types of processors entirely. In one embodiment, processor 100 includes, but is not limited to, an instruction fetch unit 101, a buffer/issue unit 105, an instruction decoder 102, one or more execution units 103, and a retirement unit 104.

Instruction fetch unit 101 is configured to fetch or prefetch instructions from an instruction cache or from memory and store the fetched instructions in buffer/issue unit 105 (also referred to as a reorder buffer). Instruction decoder 102 is to receive and decode instructions from instruction fetch unit 102 and/or buffer/issue unit 105. Instruction decoder 102 may generate and output one or more micro-operations, micro-code, entry points, microinstructions, other instructions, or other control signals, which reflect, or are derived from, the instructions. Instruction decoder 102 may be implemented using various different mechanisms. Examples of suitable mechanisms include, but are not limited to, microcode read only memories (ROMs), look-up tables, hardware implementations, programmable logic arrays (PLAs), and the like.

Execution unit(s) 103, which may include an arithmetic logic unit, or another type of logic unit capable of performing operations based on instructions (or micro-operations or μOps). As a result of instruction decoder 102 decoding the instructions, execution unit 103 may receive one or more micro-operations, micro-code entry points, microinstructions, other instructions, or other control signals, which reflect, or are derived from, the instructions. Execution unit 103 may be operable as a result of instructions indicating one or more source operands (SRC) and to store a result in one or more destination operands (DEST) of a register set indicated by the instructions. Execution unit 103 may include circuitry or other execution logic (e.g., software combined with hardware and/or firmware) operable to execute instructions or other control signals derived from the instructions and perform an operation accordingly. Execution unit 103 may represent any kinds of execution units such as logic units, arithmetic logic units (ALUs), arithmetic units, integer units, etc. After execution, exceptions are handled and retirement is made by retirement unit 104.

Some or all of the source and destination operands may be stored in registers of a register set or memory. The register set may be part of a register file, along with potentially other registers, such as status registers, flag registers, etc. A register may be a storage location or device that may be used to store data. The register set may often be physically located on die with the execution unit(s). The registers may be visible from the outside of the processor or from a programmer's perspective. For example, instructions may specify operands stored in the registers. Various different types of registers are suitable, as long as they are capable of storing and providing data as described herein. The registers may or may not be renamed. Examples of suitable registers include, but are not limited to, dedicated physical registers, dynamically allocated physical registers using register renaming, combinations of dedicated and dynamically allocated physical registers, etc. Alternatively, one or more of the source and destination operands may be stored in a storage location other than a register, such as, for example, a location in system memory.

Referring back to FIG. 1A, processor 100 further includes thread control logic 106 to determine and inform instruction fetch unit 101 which threads should be switched in for execution, and therefore which particular instructions should be fetched. The quality of the thread selection may be enhanced by thread fairness and forward progress information. According to one embodiment, thread control logic 106 includes a thread selection logic 107 and thread selection heuristics 108. Thread selection heuristics 108 is configured to store certain amounts of thread selections during previous cycles. For example, thread selection heuristics 108 may be configured to store thread selection information for prior N consecutive cycles, as well as readiness of instructions in the prior cycles or alternatively, based on the real-time readiness information. Based on thread selection heuristics 108 and the readiness information of instructions and/or μOps, according to one embodiment, thread selection logic 107 is to select one of the threads in the current cycle and to inform instruction fetch unit 101 accordingly. The information or signals concerning the actual readiness of instructions and/or μOps can be obtained from instruction fetch unit 101 and/or retirement unit 104 and/or buffer/issue unit 105.

According to one embodiment, for each thread selection point in the pipeline, there can be separate thread selection logic 107-1 to 107-N with separate algorithm and heuristics 108-1 to 108-N as shown in FIG. 1B. Over the processor pipeline, there can be multiple thread selection points. For example, there can be a thread selection point at instruction fetch unit 101, between instruction fetch unit 101 and buffer/issue unit 105, between execution unit 103 and retirement unit 104, etc. According to one embodiment, each thread selection point is associated with a separate thread selection logic and thread selection heuristics. Thus, for retirement, processing logic looks at retirement information and possibly from other units of the processor, and then feeds that back into retirement unit 104. Similarly, instruction fetch unit 101 includes feedback from previous fetch operations and other units of the processor. Both instruction fetch unit 101 and retirement unit 104 can receive feedback information from other units and factor that into the thread selection process.

According to one embodiment, an optimized thread selection scheme is employed by thread control logic 106 to select a thread (e.g., to be retired) that leads to fewer thread switching and still provides high performance. In one embodiment, in deciding which of a first thread and a second thread should be selected, thread selection logic 107 is to predict whether the first thread and second thread are ready for selection based on thread selection heuristics 108 of prior cycles. The prediction is performed based on the readiness of instructions or μOps of the threads in the last cycle immediately preceding the current cycle. One of the first and second threads is then selected based on the prediction and the determination. Note that we cannot get perfect information about what is ready in cycle 0. For example, suppose we have a 4-wide machine where 4 μOps can be ready in a cycle. Thread selection for cycle 0 happens before the effects of cycle −1 (i.e., 1 cycle earlier) are fully available. We do not see updated ready bits from those that completed in cycle −1, and we do not see any information for μOps beyond the potential selection window of 4 μOps in the previous cycle. But one can see perfect information from updated information in cycle −2 (i.e., 2 cycles earlier). So for the thread that was not selected in cycle −1, one can see those next 4 μOps, because the full effects of the actions in cycle −2 are now visible in cycle 0. If both the first and second threads are considered to be ready for selection, according to one embodiment, a contention resolution algorithm is applied to decide which of the first and second threads should be selected in the current cycle. In one embodiment, if one of the thread (e.g., first thread) was selected in the last cycle but a number of consecutive previous selections of the same thread has not exceeded a predetermined number cycles, thread selection logic 107 is to select the same thread (e.g., first thread) again in the current cycle. Otherwise, if the number of consecutive previous selections for retirement of a thread (e.g., first thread) that was selected in the last cycle has reached the predetermined threshold, thread selection logic 107 is to select another thread (e.g., second thread) for the current cycle. As a result, a thread would not be switched out even if it was selected in the last cycle, unless it has been selected for consecutive several cycles. The predetermined threshold may be configured or programmed dependent upon a specific configuration to reduce amount of thread switching while maintaining performance of the processor.

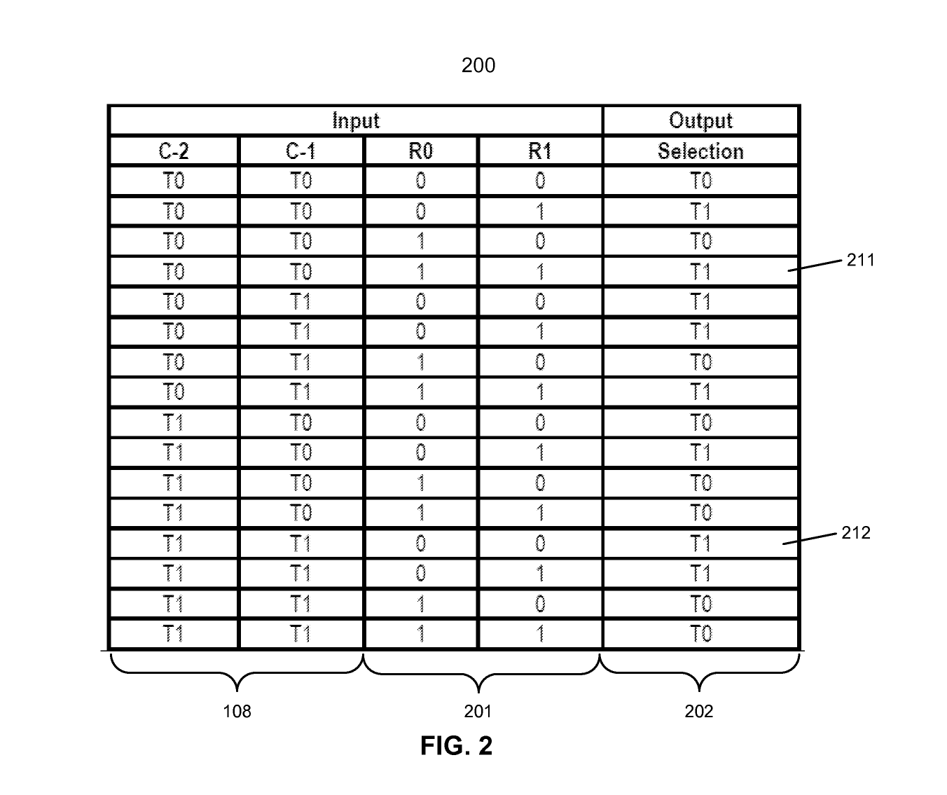

FIG. 2 is a block diagram illustrating a thread selection scheme according to one embodiment of the invention. Referring to FIG. 2, thread selection scheme 200 includes prior thread selection heuristics 108 and actual ready information of instructions or μOps of the threads 201 in those prior cycles. Based on information obtained from thread selection heuristics 108, a prediction is performed on each of threads 201 regarding whether the threads are likely ready for selection, in this example for retirement. One of the threads 201 can be selected for the current cycle based on the predictions. If all of threads 201 are ready (or are not ready) for selection, a contention resolution algorithm is applied to select one of the threads 201 in the current cycle. In this example, C-2 represents an identifier (ID) of the thread that was selected two cycles ago and C-1 represents an ID of the thread that was selected one cycle ago. R0 is 1 if thread 0 (T0) is predicted ready for selection in the current cycle and R0 is marked as 0 if thread 0 is not predicted ready for selection. Similarly, R1 is marked as 1 if thread 1 (T1) is predicted ready for selection in the current cycle and R1 is marked as 0 if thread 1 is not predicted ready for selection. Selection as an output 202 represents the ID of a thread that is selected for the current cycle. Note that in this example, although two threads are described for the purpose of illustration only, more threads can also be applied. Similarly, in this example, although thread selection information for two prior consecutive cycles is maintained as part of thread selection heuristics 108, thread selection information for more prior cycles may also be maintained.

Thus, instead of thread switching in every cycle (e.g., a PING-pong-PING-pong scheme), according to one embodiment, a thread that is selected to retire in cycle A will remain selected in cycle A+1, if it continues to have μOps ready for selection in cycle A+1. A thread switch happens only in cycle A+2 (in this example, the threshold is 2) if a different thread is also ready for selection in this cycle A+2. For a two-thread processor, this essentially performs a “PING-PING-pong-pong” selection scheme between the two threads when they both have μOps ready for selection. That is, thread switching occurs only if a thread has been selected in the last two consecutive cycles. For example, if both threads T0 and T1 are ready for selection, and if thread T0 has been selected in cycles C-1 and C-2, T1 will be selected in the current cycle (e.g., current cycle 211), or vice versa (e.g., current cycle 212). In this way, the thread switching rate is reduced by a half, which allows various thread-related signals to reduce toggling, thus saving power. The table in FIG. 2 shows the thread selection scheme 200 for a 2-thread processor. This algorithm can be generalized to perform a thread switch every N cycles, where the larger N is, the less thread switching happens (hence less power), but potentially lower SMT performance.

In one embodiment, the thread selection logic is to determine if a thread has μOps ready for selection in every cycle (i.e., R0 and R1 in the table as shown in FIG. 2) and, based on that information, the thread selection logic selects a thread in the same cycle. In one embodiment, instead of calculating accurately if a thread has ready μOps for selection in the current cycle (which may take a longer time), the previous cycle's ready information 108 is used to predict the current cycle 202. For a thread that selected some but not the maximum μOps last cycle allowed by the microarchitecture, the thread selection logic may not be able to look up the ready information for the subsequent μOps in time. As a result, certain heuristics are utilized.

In one embodiment, if in a previous cycle, among all the μOps for the thread that were selected, in this example, four μOps (0-3) that were possible for selection, μOps 1, 2, and 3 were all ready for selection, then the thread selection logic predicts that this thread continues to have μOps ready for selection in the current cycle. Alternatively, the thread select logic could consider whether μOps 0, 1, 2, and 3 were ready for selection last cycle, or just μOps 1 and 3, for the thread that was selected last cycle. For a thread that was not selected last cycle (e.g., a thread was not selected in cycle C-1), the thread selection logic will have up-to-date information, i.e., no prediction is needed, because timing allows the proper μOp ready information to be obtained. In one embodiment, a thread is ready for selection if μOp 0 is ready for selection. In other embodiments, a thread is ready for selection if several contiguous μOps are ready μOps, beginning with μOp 0.

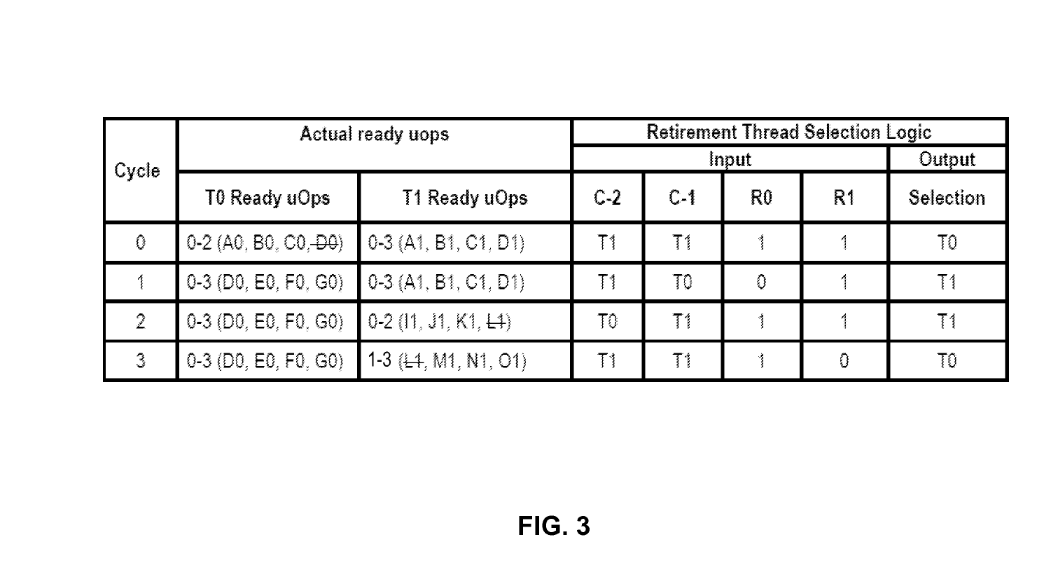

FIG. 3 is a running example illustrating an example of a thread selection according to another embodiment of the invention. Referring to FIG. 3, in this example, it is assumed that in each cycle, 0 to 4 μOps can be considered for selection (e.g., for retirement). Since μOps must be selected in the program order, μOp 1 cannot be selected (even if it is ready) if μOp 0 is not ready for selection or has not been selected, μOp 2 cannot be selected if μOp 0 or μOp 1 is not ready for selection or has not been selected, and so on. If a thread is ready for selection, then μOp 0 must be ready for selection and, furthermore, μOp 1, 2, and/or 3 may be ready for selection too. In cycle 0, T0 has μOps A0, B0, and C0 ready for selection, but not D0 (e.g., A0, B0, C0 [symbol] ), where the letter uniquely identifies a μOp and the number 0 means the μOp belongs to thread 0. A strikethrough letter, such as [symbol] , means that the μOp is not ready.

In cycle 0, T0 (thread 0) has μOps 0, 1, and 2 (e.g., A0, B0, and C0) ready for selection and T1 has μOps 0-3 (e.g., A1, B1, C1, and D1) ready for selection. However, the hardware (e.g., retirement unit) cannot know this information in cycle 0 in time; instead, it only knows about what μOps were actually ready for selection in the previous cycle. Thus, it needs to predict for both T0 and T1 whether they are ready for selection in cycle 0 based on the previous cycle's ready information. The result of this prediction is R0 and R1, which are fed into the thread selection logic. At the same time the thread selection logic also keeps track of which thread was selected in each of certain prior cycles, in this example, the past two cycles. All these 4 signals feed into the thread selection logic as inputs and the output is the thread selected in the current cycle.

In this example, the thread ready indications for cycle 0 are assumed from the previous unshown cycle and T0 is selected in cycle 0. In cycle 1, thread selection logic looks at the ready information from cycle 0. Since T0 was selected in the previous cycle, a prediction is performed to predict if T0 is ready in cycle 1 based on its ready info in cycle 0. Since T0 had only μOps A0-C0 ready for selection in cycle 0, but not D0, it is predicted to have no μOps ready for selection in cycle 1 (although it indeed has μOps D0-G0 all ready for selection in cycle 1, as shown in the table, because D0 executed and became ready during cycle 0, i.e., this is an example where the prediction can be incorrect). On the other hand, T1 had μOps A1-D1 ready for selection in cycle 0 and, since it was not selected to retire in cycle 0, its ready info in cycle 0 should remain correct in cycle 1. Thus, T1 is predicted to be ready in cycle 1. The end result is R0 is set to 0 and R1 1. Therefore, based on the thread selection scheme, and T1 is selected in cycle 1.

In cycle 2, both T0 and T1 are predicted as ready since their μOps 1-3 (e.g., μOps E0-G0 for T0 and μOps B1-D1 for T1) were all ready in cycle 1. Due to the “PING-PING-pong-pong” scheme, T1 is selected again in cycle 2 (because T1 was selected in cycle 1 and the number of consecutive selections of T1 has not reached the predetermined threshold of two in this example). In cycle 3, T0 is predicted as ready and T1 is not ready (because μOp L1 is not ready in cycle 2). Thus, T0 is selected in cycle 3. Note that even if T1 were predicted as ready, T0 would still be selected since T1 had already been selected for two consecutive cycles and the “PING-PING-pong-pong” scheme would enforce a thread switch. Note that the threshold representing a number of consecutive cycles can vary dependent upon a specific configuration. Higher threshold (e.g., a “PING-PING . . . PING-pong-pong . . . pong” scheme) may also be applied.

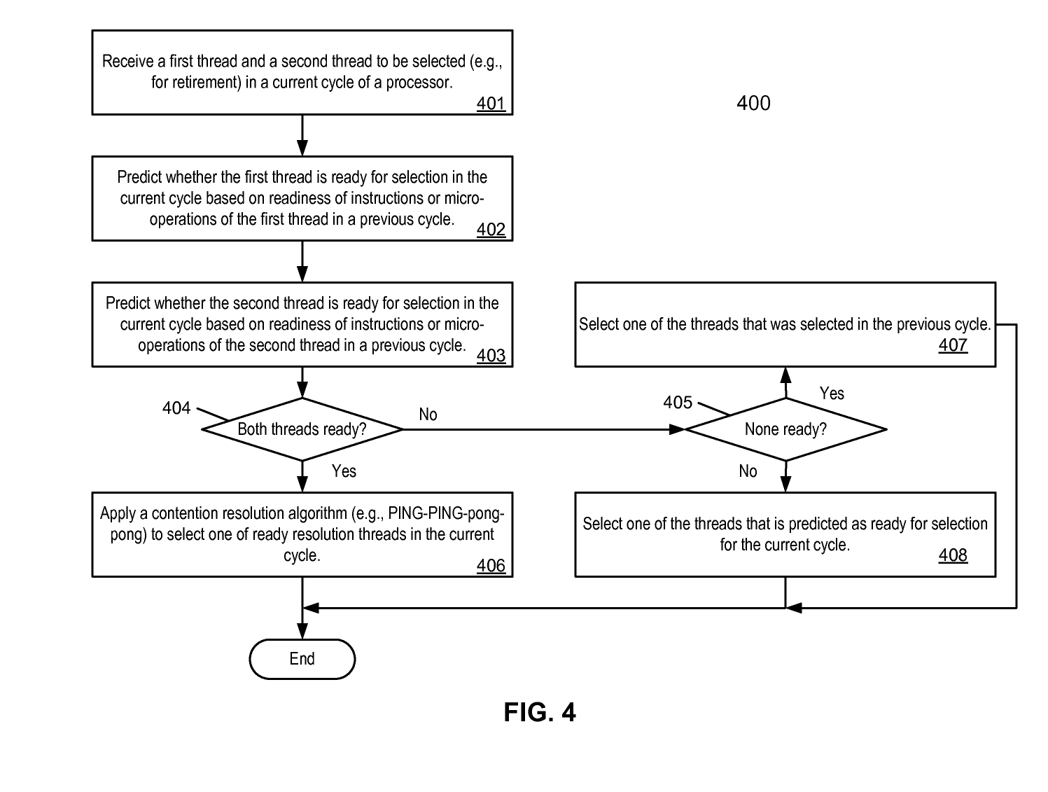

FIG. 4 is a flow diagram illustrating a method for thread retirement according to one embodiment of the invention. Method 400 may be performed by processor 100 of FIG. 1A. Referring to FIG. 4, at block 401, a first thread and a second thread are received for possible selection (e.g., for retirement) in a current cycle. At block 402, a prediction is performed on the first thread to determine the likelihood that the first thread is ready for selection in the current cycle based on readiness of instructions or μOps of the first thread in a previous cycle or cycles. Similarly at block 403, a prediction is performed on the second thread to determine the likelihood that the second thread is ready for selection in the current cycle based on readiness of instructions or μOps of the second thread in a previous cycle or cycles. At block 404, it is determined whether both of the first and second threads are predicted ready for selection in the current cycle. If not all of the first and second threads are predicted ready, at block 405, it is determined whether one of them is ready. If one of them is ready, at block 408, the ready one is selected for the current cycle. If none of them is ready, at block 407, the thread that was selected in the previous cycle is selected in the current cycle (to reduce thread switching). If both threads are predicted ready, at block 406, a contention resolution algorithm (e.g., PING-PING-pong-pong) is applied to select one of them in the current cycle. Note that there are other hints that can be used to switch the threads ahead of time when neither thread is ready. For example, if a memory miss is returning to the core for thread N, thread N will be selected.

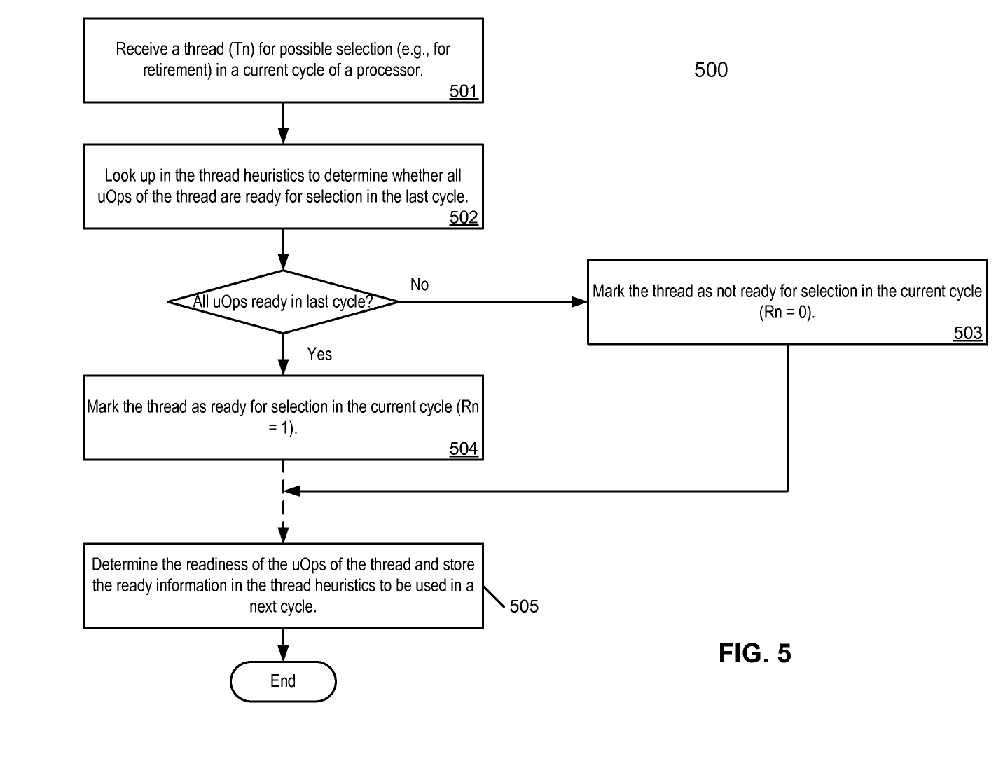

FIG. 5 is a flow diagram illustrating a method for thread retirement according to another embodiment of the invention. Method 500 may be performed as part of blocks 402-403 of FIG. 4. Referring to FIG. 5, at block 501, a thread Tn is received for possible selection (e.g., for retirement) in a current cycle. At block 502, processing logic looks up in the thread heuristics to determine whether a certain set or number of μOps were ready for selection in a previous cycle. For the thread that was selected in a previous cycle, this set of μOps includes μOps 1-3, excluding μOp 0. For the thread that was not selected in a previous cycle, this set of μOps includes only μOp 0. If not all of the μOps in this set were ready for selection in the previous cycle, at block 503, the thread Tn is marked is not ready for selection in the current cycle. Otherwise, at block 504, the thread Tn is marked as ready for selection in the current cycle. Subsequently, at block 505, readiness of μOps of the thread of the current cycle is updated in the heuristics, which may be used for predictions in a next cycle.

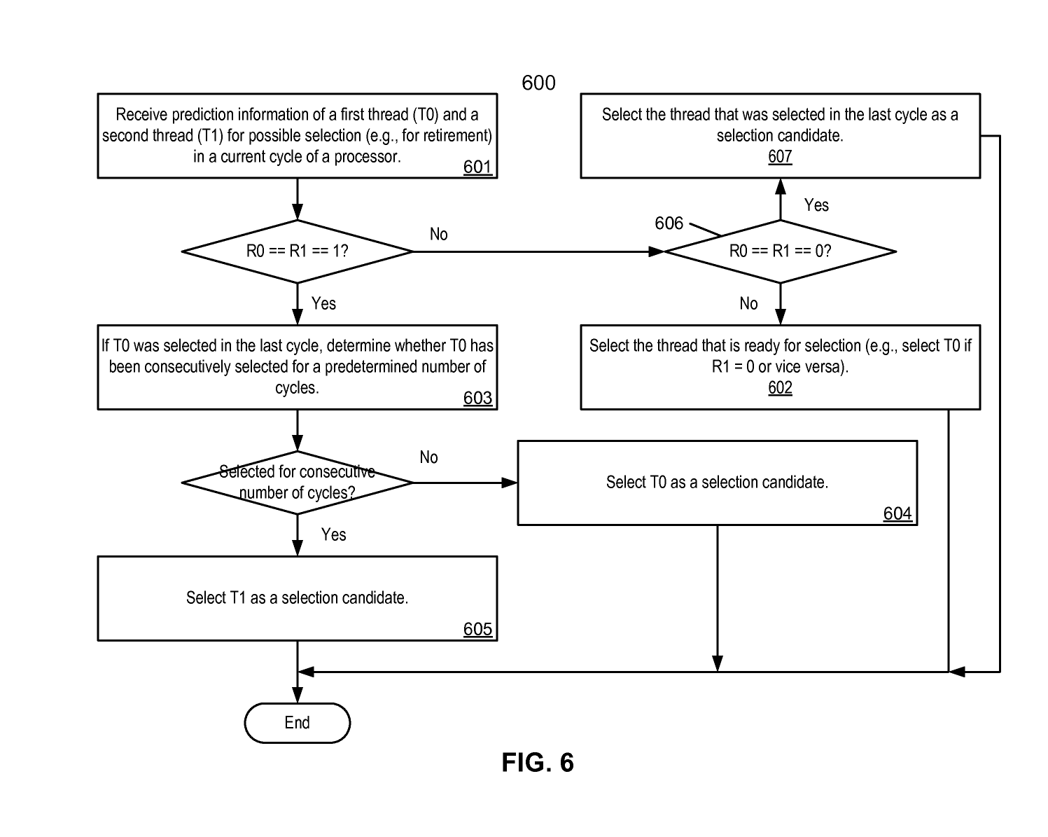

FIG. 6 is a flow diagram illustrating a method for thread selection according to another embodiment of the invention. Method 600 may be performed as part of blocks 405-408 of FIG. 4. At block 601, predictions of a first thread (T0) and a second thread (T1) are received for possible selection in a current cycle of a processor. If not all of them are predicted ready, at block 606, it is determined whether none of them is ready. If so, at block 607, the thread that was selected in the last cycle is selected in the current cycle to reduce thread switching. If one of them is ready, at block 602, the ready one is selected in the current cycle. If both threads are predicted ready, at block 603, it is determined any of the threads (T0 in this example) has been selected for a predetermined number of consecutive cycles. If so, at block 605, the other thread (T1 in this example) is selected; otherwise the same thread (T0 in this example) is selected at block 604.

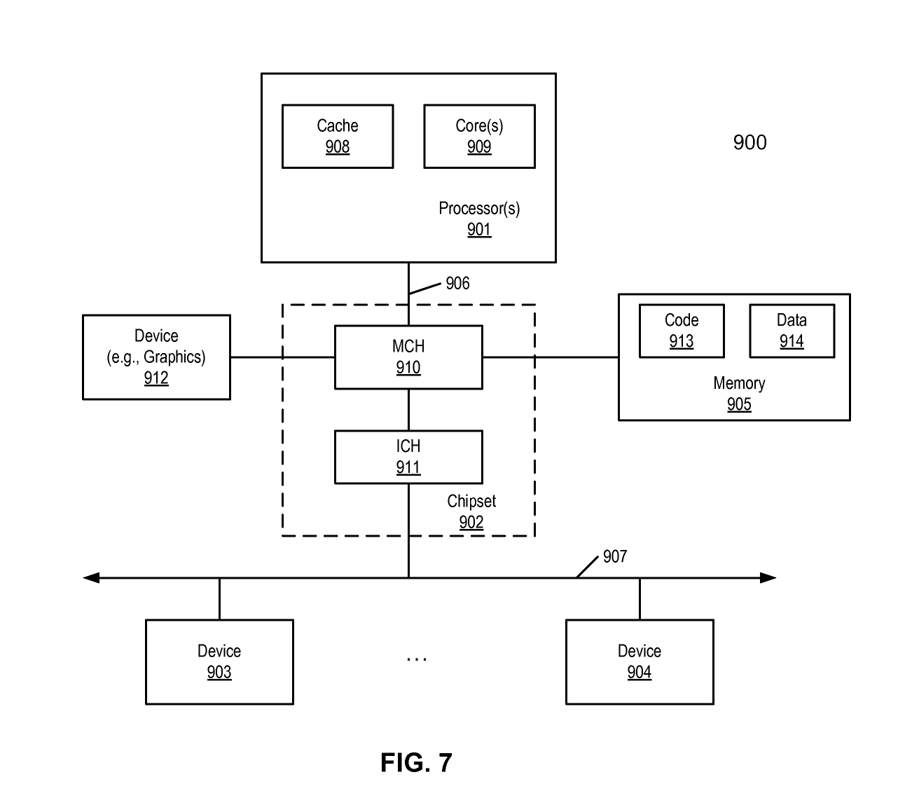

FIG. 7 is a block diagram illustrating an example of a data processing system according to one embodiment of the invention. System 900 may represent any of the systems described above. For example, processor 901 may be implemented as part of processor 100 of FIG. 1A. For example, system 900 may represent a desktop, a laptop, a tablet, a server, a mobile phone (e.g., Smartphone), a media player, a personal digital assistant (PDA), a personal communicator, a gaming device, a network router or hub, a wireless access point or repeater, a set-top box, or a combination thereof. Note that while FIG. 7 illustrates various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the present invention.

Referring to FIG. 7, in one embodiment, system 900 includes processor 901 and chipset 902 to couple various components to processor 901 including memory 905 and devices 903-904 via a bus or an interconnect. Processor 901 may represent a single processor or multiple processors with a single processor core or multiple processor cores 909 included therein. Processor 901 may represent one or more general-purpose processors such as a microprocessor, a central processing unit (CPU), or the like. More particularly, processor 901 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 901 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. For example, processor 901 may be a Pentium® 4, Pentium® Dual-Core, Core™ 2 Duo and Quad, Xeon™, Itanium™, XScale™, Core™ i7, Core™ i5, Celeron®, or StrongARM™ microprocessor available from Intel Corporation of Santa Clara, Calif. Processor 901 is configured to execute instructions for performing the operations and steps discussed herein.

Processor 901 may include an instruction decoder, which may receive and decode a variety of instructions. The decoder may generate and output one or more micro-operations, micro-code entry points, microinstructions, other instructions, or other control signals, which reflect, or are derived from, an original input instruction. The decoder may be implemented using various different mechanisms. Examples of suitable mechanisms include, but are not limited to, microcode read only memories (ROMs), look-up tables, hardware implementations, programmable logic arrays (PLAs), and the like.

The decoder may not be a required component of processor 901. In one or more other embodiments, processor 901 may instead have an instruction emulator, an instruction translator, an instruction morpher, an instruction interpreter, or other instruction conversion logic. Various different types of instruction emulators, instruction morphers, instruction translators, and the like, are known in the arts. The instruction conversion logic may receive the bit range isolation instruction, emulate, translate, morph, interpret, or otherwise convert the bit range isolation instruction, and output one or more instructions or control signals corresponding to the original bit range isolation instruction. The instruction conversion logic may be implemented in software, hardware, firmware, or a combination thereof. In some cases, some or all of the instruction conversion logic may be located off-die with the rest of the instruction processing apparatus, such as a separate die or in a system memory. In some cases, the instruction processing apparatus may have both the decoder and the instruction conversion logic.

Processor 901 and/or cores 909 may further include one or more execution units coupled with, or otherwise in communication with, an output of the decoder. The term “coupled” may mean that two or more elements are in direct electrical contact or connection. However, “coupled” may also mean that two or more elements are not in direct connection with each other, but yet still co-operate or interact or communicate with each other (e.g., through an intervening component). As one example, the decoder and the execution unit may be coupled with one another through an intervening optional buffer or other component(s) known in the arts to possibly be coupled between a decoder and an execution unit. Processor 901 and/or cores 909 may further include multiple different types of execution units, such as, for example, arithmetic units, arithmetic logic units (ALUs), integer units, etc.

Processor 901 may further include one or more register files including, but are not limited to, integer registers, floating point registers, vector or extended registers, status registers, and an instruction pointer register, etc. The term “registers” is used herein to refer to the on-board processor storage locations that are used as part of macro-instructions to identify operands. In other words, the registers referred to herein are those that are visible from the outside of the processor (from a programmer's perspective). However, the registers should not be limited in meaning to a particular type of circuit. Rather, a register need only be capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit or 64-bit integer data. A register file may contain extended multimedia SIMD registers (e.g., XMM) for packed data. Such registers may include 128 bits wide XMM registers and 256 bits wide registers (which may incorporate the XMM registers in their low order bits) relating to SSE2, SSE3, SSE4, GSSE, and beyond (referred to generically as “SSEx”) technology to hold such packed data operands.

Processor 901 and/or cores 909 may also optionally include one or more other well-known components. For example, processor 901 may optionally include instruction fetch logic, pre-decode logic, scheduling logic, re-order buffers, branch prediction logic, retirement logic, register renaming logic, and the like, or some combination thereof. These components may be implemented conventionally, or with minor adaptations that would be apparent to those skilled in the art based on the present disclosure. Further description of these components is not needed in order to understand the embodiments herein, although further description is readily available, if desired, in the public literature. There are literally numerous different combinations and configurations of such components known in the arts. The scope is not limited to any known such combination or configuration. Embodiments may be implemented either with or without such additional components.

Chipset 902 may include memory control hub (MCH) 910 and input output control hub (ICH) 911. MCH 910 may include a memory controller (not shown) that communicates with a memory 905. MCH 910 may also include a graphics interface that communicates with graphics device 912. In one embodiment of the invention, the graphics interface may communicate with graphics device 912 via an accelerated graphics port (AGP), a peripheral component interconnect (PCI) express bus, or other types of interconnects. ICH 911 may provide an interface to I/O devices such as devices 903-904. Any of devices 903-904 may be a storage device (e.g., a hard drive, flash memory device), universal serial bus (USB) port(s), a keyboard, a mouse, parallel port(s), serial port(s), a printer, a network interface (wired or wireless), a wireless transceiver (e.g., WiFi, Bluetooth, or cellular transceiver), a media device (e.g., audio/video codec or controller), a bus bridge (e.g., a PCI-PCI bridge), or a combination thereof.

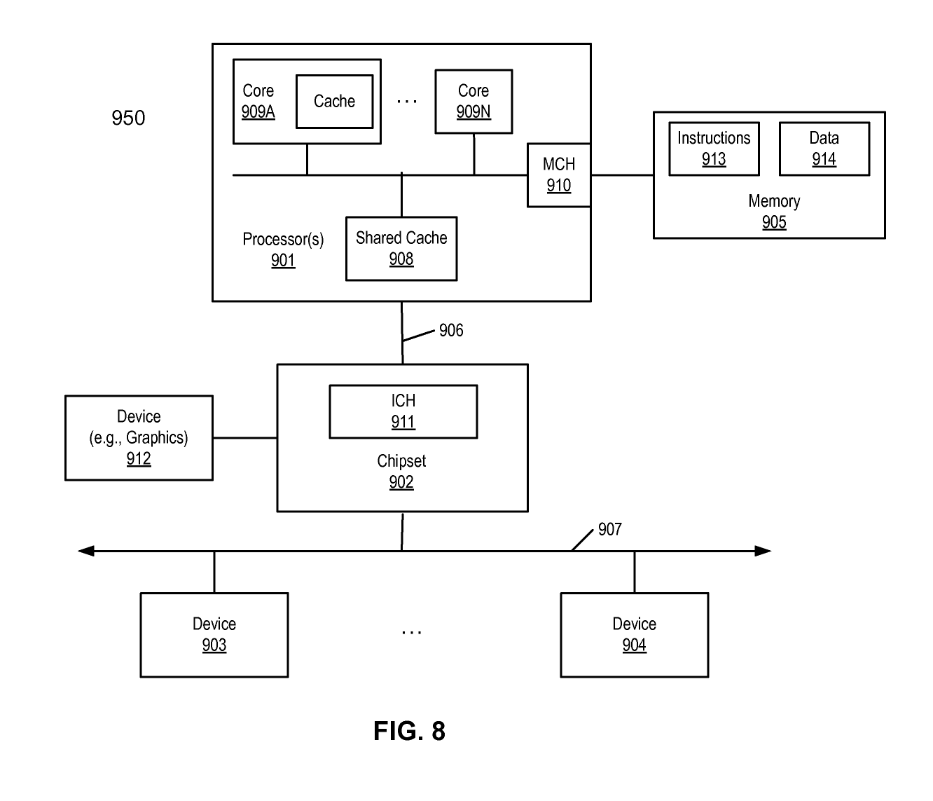

MCH 910 is sometimes referred to as a Northbridge and ICH 911 is sometimes referred to as a Southbridge, although some people make a technical distinction between them. As used herein, the terms MCH, ICH, Northbridge and Southbridge are intended to be interpreted broadly to cover various chips who functions include passing interrupt signals toward a processor. In some embodiments, MCH 910 may be integrated with processor 901. In such a configuration, chipset 902 operates as an interface chip performing some functions of MCH 910 and ICH 911, as shown in FIG. 8. Furthermore, graphics accelerator 912 may be integrated within MCH 910 or processor 901.

Memory 905 may store data including sequences of instructions that are executed by processor 901, or any other device. For example, executable code 913 and/or data 914 of a variety of operating systems, device drivers, firmware (e.g., input output basic system or BIOS), and/or applications can be loaded in memory 905 and executed by processor 901. An operating system can be any kind of operating systems, such as, for example, Windows® operating system from Microsoft®, Mac OS®/iOS® from Apple, Android® from Google®, Linux®, Unix®, or other real-time operating systems. In one embodiment, memory 905 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk or a flash storage device. Front side bus (FSB) 906 may be a multi-drop or point-to-point interconnect. The term FSB is intended to cover various types of interconnects to processor 901. Chipset 902 may communicate with other devices such as devices 903-904 via point-to-point interfaces. Bus 906 may be implemented as a variety of buses or interconnects, such as, for example, a quick path interconnect (QPI), a hyper transport interconnect, or a bus compatible with advanced microcontroller bus architecture (AMBA) such as an AMBA high-performance bus (AHB).

Cache 908 may be any kind of processor cache, such as level-1 (L1) cache, L2 cache, L3 cache, L4 cache, last-level cache (LLC), or a combination thereof. Cache 908 may be shared with processor cores 909 of processor 901. Cache 908 may be embedded within processor 901 and/or external to processor 901. Cache 908 may be shared amongst cores 909. Alternatively, at least one of cores 909 further includes its own local cache embedded therein. At least one of cores 909 may utilize both the local cache and the cache shared with another one of cores 909. Processor 901 may further include a direct cache access (DCA) logic to enable other devices such as devices 903-904 to directly access cache 908. Processor 901 and/or chipset 902 may further include an interrupt controller, such as an advanced programmable interrupt controller (APIC), to handle interrupts such as message signaled interrupts.

An example of embodiments of the invention includes a processor having one or more execution units to execute instructions of a plurality of threads, thread control logic coupled to the execution units to select the plurality of threads, where the thread control logic to predict whether a first of the plurality of threads is ready for selection in a current cycle based on readiness of instructions of the first thread in one or more previous cycles, predict whether a second of the plurality of threads is ready for selection in the current cycle based on readiness of instructions of the second thread in the one or more previous cycles, and select one of the first and second threads in the current cycle based on the predictions.

The thread control logic is further to determine whether both the first and the second threads are predicted as ready for selection, and apply a contention resolution algorithm to select one of the first and second threads in the current cycle, if both the first and the second threads are predicted as ready for selection. In applying the contention resolution algorithm, the thread control logic is configured to determine whether the first thread has been selected for a consecutive number of previous cycles immediately preceding the current cycle that exceeds a predetermined threshold, select the second thread for the current cycle if the first thread has been selected for retirement for a consecutive number of previous cycles immediately preceding the current cycle that exceeds the predetermined threshold, and select the first thread for the current cycle if the first thread has not been selected for the consecutive number of previous cycles exceeding the predetermined threshold.

The predetermined threshold is two consecutive cycles. If none of the first and second threads is predicted as ready for selection, the thread control logic is configured to select one of the first and second threads that was selected in a previous cycle. In predicting the first thread, the thread control logic is configured to determine whether at least a predetermined number or a predetermined set of the instructions of the first thread have been selected in the previous cycle, indicate the first thread as ready for selection if the predetermined number or a predetermined set of the instructions of the previous cycle have been selected, and indicate the first thread as not-ready for selection if fewer than the predetermined number or a predetermined set of the instructions of the previous cycle have been selected.

If the first thread was not selected in the previous cycle, the thread control logic is configured to determine readiness of the first thread based on actual readiness information of the instructions. The thread control logic is to maintain heuristics information concerning readiness of instructions of the first and second threads and thread selections in one or more prior cycles. The previous cycle is a cycle immediately preceding the current cycle, and wherein the thread control logic is further to obtain readiness of instructions of the first and second threads in the current cycle and to store the readiness of instructions as part of the heuristics information to be utilized in a next cycle following the current cycle. One of the first and second threads is selected for thread retirement.

An example of embodiments of the invention further includes a method. The method includes predicting whether a first of a plurality of threads is ready for selection in a current cycle based on readiness of instructions of the first thread in one or more previous cycles, the plurality of threads having instructions being executed by one or more execution units of a processor; predicting whether a second of the plurality of threads is ready for selection in the current cycle based on readiness of instructions of the second thread in the one or more previous cycles, and selecting one of the first and second threads in the current cycle based on the predictions.

The method further includes determining whether both the first and the second threads are predicted as ready for selection; and applying a contention resolution algorithm to select one of the first and second threads for selection in the current cycle, if both the first and the second threads are predicted as ready for selection. The applying the contention resolution algorithm includes determining whether the first thread has been selected for a consecutive number of previous cycles immediately preceding the current cycle that exceeds a predetermined threshold; selecting the second thread for the current cycle if the first thread has been selected for a consecutive number of previous cycles immediately preceding the current cycle that exceeds the predetermined threshold; and selecting the first thread for the current cycle if the first thread has not been selected for the consecutive number of previous cycles exceeding the predetermined threshold.

The predetermined threshold is two consecutive cycles. The method further includes selecting one of the first and second threads that was selected in a previous cycle, if none of the first and second threads is predicted as ready. The predicting the first thread includes determining whether a predetermined number or a predetermined set of instructions of the first thread have been selected in the previous cycle; indicating the first thread as ready for retirement if at least the predetermined number or the predetermined set of instructions of the previous cycle have been selected; and indicating the first thread as not-ready for retirement if fewer than the predetermined number or the predetermined set of instructions of the previous cycle have been selected.

The method further includes determining readiness of the first thread based on actual readiness information of the instructions of the first thread, if the first thread was not selected in the previous cycle. The method further includes maintaining heuristics information concerning readiness of instructions of the first and second threads and thread selections in one or more prior cycles. The previous cycle is a cycle immediately preceding the current cycle, and the method further includes obtaining readiness of instructions of the first and second threads in the current cycle; and storing the readiness of instructions as part of the heuristics information to be utilized in a next cycle following the current cycle. An embodiment of the invention further includes a data processing system to perform the method set forth above.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A processor, comprising:
one or more execution units to execute instructions of a plurality of threads; and
thread control logic coupled to the execution units to
predict whether a first of the plurality of threads is ready for selection in a current cycle based on readiness of instructions of the first thread in one or more previous cycles,
predict whether a second of the plurality of threads is ready for selection in the current cycle based on readiness of instructions of the second thread in the one or more previous cycles, and
select one of the first and second threads in the current cycle based on the predictions.

2. The processor of claim 1, wherein the thread control logic is further to
determine whether both the first and the second threads are predicted as ready for selection, and
apply a contention resolution algorithm to select one of the first and second threads in the current cycle, if both the first and the second threads are predicted as ready for selection.

3. The processor of claim 2, wherein in applying the contention resolution algorithm, the thread control logic is configured to
determine whether the first thread has been selected for a consecutive number of previous cycles immediately preceding the current cycle that exceeds a predetermined threshold,
select the second thread for the current cycle if the first thread has been selected for retirement for a consecutive number of previous cycles immediately preceding the current cycle that exceeds the predetermined threshold, and
select the first thread for the current cycle if the first thread has not been selected for the consecutive number of previous cycles exceeding the predetermined threshold.

4. The processor of claim 3, wherein the predetermined threshold is two consecutive cycles.

5. The processor of claim 2, wherein if none of the first and second threads is predicted as ready for selection, the thread control logic is configured to select one of the first and second threads that was selected in a previous cycle.

6. The processor of claim 1, wherein in predicting the first thread, the thread control logic is configured to
determine whether at least a predetermined number or a predetermined set of the instructions of the first thread have been selected in the previous cycle,
indicate the first thread as ready for selection if the predetermined number or a predetermined set of the instructions of the previous cycle have been selected, and
indicate the first thread as not-ready for selection if fewer than the predetermined number or a predetermined set of the instructions of the previous cycle have been selected.

7. The processor of claim 6, wherein if the first thread was not selected in the previous cycle, the thread control logic is configured to determine readiness of the first thread based on actual readiness information of the instructions.

8. The processor of claim 1, wherein the thread control logic is to maintain heuristics information concerning readiness of instructions of the first and second threads and thread selections in one or more prior cycles.

9. The processor of claim 8, wherein the previous cycle is a cycle immediately preceding the current cycle, and wherein the thread control logic is further to obtain readiness of instructions of the first and second threads in the current cycle and to store the readiness of instructions as part of the heuristics information to be utilized in a next cycle following the current cycle.

10. The processor of claim 1, wherein one of the first and second threads is selected for thread retirement.

11. A computer-implemented method, comprising:
predicting whether a first of a plurality of threads is ready for selection in a current cycle based on readiness of instructions of the first thread in one or more previous cycles, the plurality of threads having instructions being executed by one or more execution units of a processor;
predicting whether a second of the plurality of threads is ready for selection in the current cycle based on readiness of instructions of the second thread in the one or more previous cycles, and
selecting one of the first and second threads in the current cycle based on the predictions.

12. The method of claim 11, further comprising:
determining whether both the first and the second threads are predicted as ready for selection; and
applying a contention resolution algorithm to select one of the first and second threads for selection in the current cycle, if both the first and the second threads are predicted as ready for selection.

13. The method of claim 12, wherein applying the contention resolution algorithm comprises:
determining whether the first thread has been selected for a consecutive number of previous cycles immediately preceding the current cycle that exceeds a predetermined threshold;
selecting the second thread for the current cycle if the first thread has been selected for a consecutive number of previous cycles immediately preceding the current cycle that exceeds the predetermined threshold; and
selecting the first thread for the current cycle if the first thread has not been selected for the consecutive number of previous cycles exceeding the predetermined threshold.

14. The method of claim 13, wherein the predetermined threshold is two consecutive cycles.

15. The method of claim 12, further comprising selecting one of the first and second threads that was selected in a previous cycle, if none of the first and second threads is predicted as ready.

16. The method of claim 11, wherein predicting the first thread comprises:
determining whether a predetermined number or a predetermined set of instructions of the first thread have been selected in the previous cycle;
indicating the first thread as ready for retirement if at least the predetermined number or the predetermined set of instructions of the previous cycle have been selected; and
indicating the first thread as not-ready for retirement if fewer than the predetermined number or the predetermined set of instructions of the previous cycle have been selected.

17. The method of claim 16, further comprising determining readiness of the first thread based on actual readiness information of the instructions of the first thread, if the first thread was not selected in the previous cycle.

18. The method of claim 11, further comprising maintaining heuristics information concerning readiness of instructions of the first and second threads and thread selections in one or more prior cycles.

19. The method of claim 18, wherein the previous cycle is a cycle immediately preceding the current cycle, and wherein the method further comprises
obtaining readiness of instructions of the first and second threads in the current cycle; and
storing the readiness of instructions as part of the heuristics information to be utilized in a next cycle following the current cycle.

20. A data processing system, comprising:
a dynamic random-access memory (DRAM); and
a processor coupled to the DRAM, the processor including
one or more execution units to execute instructions of a plurality of threads, and
thread control logic coupled to the execution units to perform a method of any of claims 11-19.
